(19) United States
(12) Patent Application Publication
(10) Pub. No.: US 2009/0047948 A1
(43) Pub. Date: Feb. 19, 2009

(54) MOBILE NETWORKING METHOD AND SYSTEM

(75) Inventors: Eliyahu Turetsky, Beit Shemesh (IL); Roman Kazarnovski, Modiin (IL)

Correspondence Address: HESLIN ROTHENBERG FARLEY & MESITI PC, 5 COLUMBIA CIRCLE, ALBANY, NY, 12203, US

(73) Assignee: TCM MOBILE LLC, Overland Park, KS (US)

(21) Appl. No.: 12/190,952

(22) Filed: Aug. 13, 2008

Related U.S. Application Data
(60) Provisional application No. 60/935,523, filed on Aug. 16, 2007.

(51) Int. Cl. H04W 4/00

(52) U.S. Cl. 455/432.1

(57) ABSTRACT

A dynamically adapted network environment is disclosed. The dynamically adapted network environment has one or more mobile objects (MO's) and one or more corresponding network neighborhoods. Each of the one or more MO's is the center of a corresponding network neighborhood which is adapted locally to accommodate a movement of its corresponding MO in a manner that sustains substantially seamless communication traffic. A method of enabling seamless wireless roaming of a mobile object (MO) on a wireless network is also disclosed. A network neighborhood is defined for the MO based at least on a location of the MO. Communication traffic associated with the MO is buffered for redirection to at least one predicted future network connection point (NCP) which is part of the network neighborhood.

### RELATED APPLICATIONS

This application claims priority to U.S. provisional patent application 60/935,523, entitled, “A MOBILE NETWORKING METHOD FOR WIRELESS DEVICES AND A SYSTEM THEREOF” which was filed on Aug. 16, 2007. U.S. provisional patent application 60/935,523 is hereby incorporated by reference in its entirety.

### FIELD

The claimed invention generally relates to networking of mobile devices, and more particularly to methods and systems enabling seamless wireless roaming of mobile devices.

### BACKGROUND

The proliferation of wireless access points (AP's) which may be coupled to a wide-area network (WAN), such as the internet, or a local-area network (LAN), has made it possible to wirelessly send and receive data packets, such as TCP/IP or UDP/IP packets to and from a variety of wireless devices and wired devices which are connected to the network. A variety of protocols may be used to support the physical layer connection of the wireless devices to the AP's, for example the IEEE 802.11 protocol. At the same time that such wireless infrastructure is growing, algorithms referred to as “codecs” have been developed to sample and code conversation into voice data packets. The codecs can also decode the voice data packets and convert them into audible conversation. By combining codec technology and a wireless protocol such as 802.11 into mobile phones, such mobile phones can send and receive voice data packets via a wireless access point (AP). One type of voice data packet format which is gaining in popularity is voice-over-IP (VoIP).

FIG. 1 schematically illustrates one embodiment of a VoIP system 20 which supports a plurality of wireless (and therefore, potentially mobile) VoIP phones 22A, 22B, 22C. A plurality of access points 24A, 24B, and 24C are coupled to a VoIP core controller 26. For simplicity, the element 26 will be referred-to as a VoIP core controller, but it should be understood that element 26 can be a VoIP core controller and/or a WiFi controller. The VoIP core controller 26 coordinates the overall VoIP system 20. Each VoIP phone 22 can wirelessly connect to an AP 24, for example, using the 802.11 protocol. When the phone 22 associates with an AP 24, the phone 22 can then register with the VoIP core controller 26 via the AP 24. The VoIP core controller 26 manages IP address assignments for each of the registered devices, tracks which AP 24 the portable device is communicating through, and assists in routing data to and from the mobile phone 22. The VoIP core controller 26 may be a computer, laptop, processor, networking device, server, microprocessor, application specific integrated circuit (ASIC), analog electrical component, digital electrical component, any plurality there-of, or any combination thereof. The VoIP core controller 26 may be localized or distributed. The VoIP core controller 26 may facilitate voice conversations between multiple wireless phones 22, and may optionally be coupled to one or more public service telephone networks (PSTN) 28, for example via a voice gateway, to enable the VoIP phone 22 to make calls to more traditional phone systems, and visa-versa.

The AP's 24 may be coupled to the VoIP core controller 26 in a variety of ways. As one example, an AP 24A may be hard-wired 30 to the VoIP core controller 26, for example by an Ethernet or an ISDN connection. As another example, an AP 24B may be wirelessly connected 32 with the VoIP core controller 26, for example, by using an 2.4 GHz or a 5 GHz wireless protocol. As a further example, an AP 24C may be coupled to the VoIP core controller 26 by a network 34. The network 34 could be wide area network (WAN) or a local area network (LAN).

Each AP 24 will have an associated coverage area 36. In this embodiment, the AP coverage areas 36 are illustrated as being circular and of the same size. It should be understood, however, that the AP coverage areas 36 do not necessarily have to be circular. AP antennas may be designed to broadcast differing coverage shapes. Furthermore, AP antennas may have different power levels, which can lead to different size coverage areas, even from the same style antenna. When a VoIP mobile phone 22 (sometimes referred-to as a “client”) is within the coverage area 36, it can wirelessly connect 38 to the AP 24 in the coverage area 36. If the VoIP mobile phone 22 moves outside of the coverage area 36, it can not connect to the AP 24.

Assuming, for simplicity, a circular coverage area 36, an AP 24 will typically have a coverage area 36 having a maximum radius of a few hundred feet. As compared to cellular mobile technology (such as GSM, or CDMA) which has a cellular radius of approximately 2 miles, it is apparent that VoIP-type systems must have far more AP's 24 in order to have complete coverage over a similar area. An effective VoIP system 20 will therefore have many overlapping coverage areas. Although the AP's 24 in the embodiment of FIG. 1 are not illustrated as overlapping, the coverage areas I, II, and III in the embodiment of FIG. 2 do overlap. Given the relatively close distribution of AP's which is necessary in VoIP systems in order to have overlapping coverage areas, it is likely that a user of a VoIP mobile phone who is on the move will have a frequent need to roam from one AP to another AP during a call.

FIG. 2 schematically illustrates another embodiment of a VoIP system 40. Three AP's 42, 44, 46 are illustrated in this embodiment. AP coverage area I is provided by AP 42, AP coverage area II is provided by AP 44, and AP coverage area III is provided by AP 46. AP's 42 and 44 are connected to a network 34 via respective “layer 2” switches 48 and 50, and via subnet A router 52. AP 46 is connected to network 34 via switch 54 and subnet B router 56. In this embodiment, when a VoIP mobile phone 58 moves from coverage area I to coverage area II, it can simply re-associate from the first AP 42 to the second AP 44 because the “layer 3” network address is maintained due to the common subnet A router 52 shared by the AP's 42, 44. Being able to maintain the layer 3 network address means that the IP address assigned to the VoIP mobile phone 58 does not need to change when the phone 58 re-associates with AP 44. The 802.11 specification addresses this type of re-association.

Unfortunately, IP addresses cannot always be maintained when roaming from one AP to another. For example, when a second VoIP mobile phone 60 moves from coverage area II to coverage area III, it cannot simply re-associate from the second AP 44 to the third AP 46 because the layer 3 network address cannot be maintained. AP's 44 and 46 are on different subnets, and therefore the phone 60 will need a new IP address mapped to it before it can communicate with AP 54. Unfortunately, there is no standard procedure for this type of AP transfer in the 802.11 specification or otherwise. If only the 802.11 specification is relied on for this type of roaming, then a call in-progress during a move from coverage area II to coverage area III would be dropped.

The realities of actual VoIP coverage areas exacerbate the need for a method and system to deal with wireless VoIP roaming. FIG. 3 schematically illustrates one embodiment of distributed access points (AP's) for multiple service providers and their corresponding coverage areas. In this more faithful-to-real-life example, two sets of overlapping provider VoIP coverage areas are illustrated. The dots represent AP's for a first provider, provider A. The coverage areas for each AP in provider A's network are shown as a solid line circle. The x's represent AP's for a second provider, provider B. The coverage areas for each AP in provider B's network are shown as a dashed line circle. Also thrown into the mix is a personal AP 62 which is represented by a triangle. The personal AP 62 could be someone's wireless AP in their house. The coverage area for the personal AP is shown as a partially broken circle.

Not even taking movement into account, VoIP mobile phones located in the system of FIG. 3 may be presented with a variety of connection options, depending on where they are located. Some locations will only have one connection option. For example, phone 64 can only connect to AP 66 on provider B's network, phone 68 can only connect to AP 70 on provider A's network, and phone 72 can only connect to the personal AP 62. Other phones will have multiple connection options within a single provider's network. For example, phone 74 can connect to either AP 76, AP 78, or AP 80 on provider A's network. Single providers may desire to create highly overlapping AP's (such as AP's 76, 78, 80) since the number of users who can connect to a single AP are limited. Still other phones will have multiple connection options, each for a variety of networks. For example, phone 82 can connect to AP 84 on provider A's network, AP 86 on provider B's network, or personal AP 62. Still other phones will have multiple connection options for multiple networks. For example, phone 88 can connect to AP's 90 and 92 on provider A's network and to AP's 94, 96 on provider B's network.

When one adds the complication of movement to the scenario of FIG. 3, it can be appreciated how important it will be to enable phones to roam from one AP to another in a way which does not drop phone calls or cause breaks in conversations. Large networks have to be divided into many subnets and therefore, permanent IP's can not be used.

In addition to supporting wireless phones, wireless networks can also support a host of other mobile objects, such as, but not limited to medical monitoring devices, public safety monitoring devices, and even mobile routers. Wireless networks have become popular due to ease of installation, and location freedom. An ever increasing number of businesses such as coffee shops or shopping malls have begun to offer wireless access to their customers and frequently free of charge. The demand for wireless access is ever increasing and large wireless network projects are being put up in many major cities to supply that ever increasing demand.

In contrast to cellular networks, wireless networks are configured based on local networks which were designed to support non-mobile computing devices. Hence the addressing methods utilized by the protocols of mobile devices is only locally based, meaning that the addresses of network components are determined by the components' location in the local network surroundings. A network object is characterized by a Network Identifier (NI), connected to a specific node.

Rapid advances in technology have led to a widespread use of intelligent mobile devices, such as, but not limited to mobile phones, personal digital assistants (PDA's), smart phones, digital cameras, digital camcorders, and digital music players. These intelligent mobile devices, especially voice or multimedia devices, have a requirement for uninterrupted communication when they are moving. Unfortunately, for at least the above discussed reasons, the present structure of wireless networks does not accommodate seamless communication of mobile devices. For example, according to the standard wireless network protocol IEEE 802.11, when an intelligent device connected to a wireless network is moving away from the network access point and the signal level is reduced below an adequate detection level, the communication link used by the device is disconnected abruptly.

As one possible solution to minimize the effect of abrupt network disconnections, a network user environment can be adopted for supporting a moving Mobile Object (MO) at any network location by forwarding to a targeted network the MO information about the moving intention. This technique is assisted by a registration process of the MO at the new network and further enhanced by periodically repeating the registration process. Nevertheless, existing methods do not provide, as of yet, a robust and cost effective solution to this problem due to several reasons explained in the subsequent section.

One of the reasons is associated with layer 2 and layer 3 roaming problems. The term ‘roaming’ refers to extending of connectivity service in a location that is different from the home location where the service was registered and providing the ability for a network user to automatically send and receive data, or access other services, when traveling outside the geographical coverage area of the home network, by means of using a visited network. This can be done by using a communication terminal or else just by using the subscriber identity in the visited network. Roaming is technically supported by mobility management, authentication, authorization, and billing procedures.

The level 2 roaming problem is associated with lost information on the data link layer of the protocol. Communication traffic at the data link layer level stops at once, when the Network Connection Point (NCP) of the MO changes. This brings about an information loss of the network link, in the event that connectionless protocols are used concurrently on the transport layer.

The level 3 roaming problem is associated with routing problems that are introduced on the network layer. Network links, from the transport level and up, break when the NCP of the MO changes, resulting in routing problems on the network layer.

As mentioned, the IEEE 802.11 standard for wireless local area networks (WLAN) does not address the level 2 roaming problem. WLAN vendors are left to implement their own solutions to the problem and each vendor keeps its solution confidential and incompatible with other solutions.

Since roaming techniques of wireless networks are kept confidential, it is assumed, based on the present art that an MO initiates the change in the network connection point in most commercially available systems. Furthermore, data loss set off by the level 2 roaming problem exists in the system despite the algorithms of data traffic caching claimed by some vendors and presented in their literature.

Another approach to mobile wireless network roaming is based on the usage of a permanent IP address by the wireless devices. There are different techniques for implementing the permanent IP address approach. One optional solution utilizes a long distance connection to a Network Service Provider (NSP), via a satellite link, a dedicated long distance radio connection, or cellular service connections. Unfortunately, this approach is extremely expensive and therefore not practical for implementation. Another approach to roaming of mobile wireless networks is based on utilizing flat networks, whereas subnets are excluded from the network. This approach is not practical since information traffic is substantially limited by the fact that one single link is common to all the data traffic.

Several alternate mobile IP standards have been developed during recent years, for example: RFC 2002 and RFC 2344. These standards specify and use communication channels created between the network connection point and the permanent IP provider. RFC 2002 for example, is a protocol enhancement that allows transparent routing of IP data to mobile nodes in on Internet. Each mobile node is always identified by its home address, regardless of its current point of attachment to the Internet. While situated away from its home, a mobile node is also associated with a care-of address, which provides information about its current point of attachment to the Internet. The protocol provides for registering the care-of address with a home agent. The home agent sends data destined for the mobile node through a tunnel to the care-of address. After arriving at the end of the tunnel, data is then delivered to the mobile node. Unfortunately, the implementation of this technique requires allocating software resources of the MO as well as special resources of the network infrastructure, and therefore requires proprietary modifications to the end-user device to participate. The RFC standards have been used by distinct vendors during the past years yet never gained real popularity and widespread industry use.

U.S. Pat. No. 7,127,258, incorporated herein by reference, discloses a wireless data communication system having mobile units which become associated with access points. Association between a mobile unit and an access point is changed by a cell controller as mobile units move within an area having a plurality of access points. Selection of an access point for association with a mobile unit is made by a central cell controller according to selection criteria including a plurality of selection parameters. In order to enforce which access points a mobile unit may connect-to, the central controller selectively allows or blocks a mobile device's request for connection at various access points. The system also includes arrangements for determining location of a mobile unit within the area. The selection parameters include location of the mobile unit or direction of movement of the mobile unit. While there may be ways of determining the general location and movement vector of a mobile device, this patent unfortunately, does not provide a solution to the dropped or interrupted call issue which arises when the mobile device transfers between allowed access points.

U.S. Pat. No. 6,243,581, incorporated herein by reference, discloses a mobile computer system capable of seamless roaming between wireless communication networks. The system includes a plurality of wireless interfaces that support simultaneous wireless connections with first and second wireless communication networks, and a network access arbitrator that routes data communicated between the system and the first and second wireless communication networks. Seamless roaming is enabled by the network access arbitrator which routes the data to the first wireless communication network via a first wireless interface and then seamlessly reroutes the data to a second wireless communication network via a second wireless interface. According to one embodiment, the network access arbitrator reroutes the data in response to the data bandwidths at the connections with the first and second wireless communication networks. Unfortunately, since such methods require a plurality of transceivers in a mobile device to support the simultaneous wireless connections, they are more complex and more expensive to implement.

U.S. Pat. No. 6,577,609, incorporated herein by reference, discloses a method and an apparatus for operating a packet data communications network including a plurality of access points and a plurality of remote mobile wireless units. At least two of the disclosed mobile units are capable of communicating with at least one of the access points. When the mobile units are located within a predetermined range of the access point, they can be associated with that access point. The disclosed method includes a step establishing an association between the mobile units and the access points utilizing a packet frame addressing protocol including a multicast address. The method further includes a step of receiving in one of the access points at least two distinct sequences of packets addressed to at least two mobile units respectively associated with the access point. The method further includes forming a frame in the access point, with a multicast address including the address of at least two of the mobile units, and including in the data field of the frame unicast packets addressed to each of at least two of the mobile units. The method finally includes transmitting the frame to the mobile units by the one access point.

None of the currently available methods of networking mobile devices has ever been widely adopted by the industry, hence there is still a long felt and growing need for an adequate and acceptable solution to the problem of networking mobile wireless devices so that voice calls and other multimedia data transfers are not dropped or interrupted.

Therefore, it is desirable to have a mobile networking method which economically and efficiently allows for mobile objects to roam among the access points of one or more networks, while minimizing disruptions, breaks, and delays to the data transfer continuity and which allows existing mobile objects to roam without the need for proprietary communication modifications to the mobile objects.

### SUMMARY

A dynamically adapted network environment is disclosed. The dynamically adapted network environment has one or more mobile objects (MO's) and one or more corresponding network neighborhoods. Each of the one or more MO's is the center of a corresponding network neighborhood which is adapted locally to accommodate a movement of its corresponding MO in a manner that sustains substantially seamless communication traffic.

A method of identifying a network neighborhood for a mobile object (MO) is also disclosed. A location of the MO is determined. One or more other network connection points (NCP's) are predicted, the predicted NCP's being ones which the MO is likely to connect-to in addition to a current NCP based on at least the location of the MO. Any network objects necessary to provide communication traffic between the current NCP and the one or more other NCP's are identified. The network neighborhood for the MO is identified as including the current NCP, the one or more other NCP's, and the one or more network objects.

A method of enabling seamless wireless roaming of a mobile object (MO) on a wireless network is also disclosed. A network neighborhood is defined for the MO based at least on a location of the MO. Communication traffic associated with the MO is buffered for redirection to at least one predicted future network connection point (NCP) which is part of the network neighborhood.

A system for mobile networking is also disclosed. The system has a controller; a plurality of network connection points (NCP's) configured to communicate with a mobile object (MO); and at least one network object which couples the plurality of NCP's to the controller. One or more of the controller, the plurality of NCP's, and the at least one network object are configured to: 1) define a network neighborhood for the MO based at least on a location of the MO; and 2) buffer communication traffic associated with the MO for redirection to at least one predicted future network connection point (NCP) which is part of the network neighborhood.

### BRIEF DESCRIPTION OF THE DRAWINGS

FIG. 1 schematically illustrates one embodiment of a wireless communication system.

FIG. 2 schematically illustrates another embodiment of a wireless communication system.

FIG. 3 schematically illustrates one embodiment of distributed access points (AP's) for multiple service providers and their corresponding coverage areas.

FIG. 4 schematically illustrates one embodiment of a dynamically adapted network environment.

FIG. 5 illustrates one embodiment of a method of identifying a network neighborhood for a mobile object (MO).

FIGS. 6A-6E schematically illustrate example embodiments of predicted network connection points which are assigned to part of a network neighborhood based on at least a location of a mobile object (MO).

FIGS. 7A-7C schematically illustrate example embodiments of network objects which are included in a network neighborhood definition based on a current network connection point (NCP) and predicted NCP's which a mobile object (MO) might connect-to.

FIG. 8A schematically illustrates an embodiment of a mobile object (MO) which is connected to a first network connection point (NCP) at a first time, and then is connected to a second NCP at a later time.

FIG. 8B illustrates an embodiment of a timing diagram correlating to the transition of the mobile object (MO) of FIG. 8A from a first to a second NCP in such a way that the reconnection process is substantially seamless.

FIG. 9 illustrates one embodiment of a method of enabling seamless wireless roaming of a mobile object (MO) on a wireless network.

FIG. 10 illustrates another embodiment of a method of enabling seamless wireless roaming of a mobile object (MO) on a wireless network.

FIG. 11 schematically illustrates one embodiment of a system for mobile networking.

FIG. 12 schematically illustrates one embodiment of a network including a single mobile object (MO) connected to a first network node, wherein a first embodiment of a network neighborhood is defined for the mobile object.

FIG. 13 schematically illustrates the embodiment network of FIG. 12, wherein a second embodiment of a network neighborhood is defined for the mobile object based on a location change of the mobile object.

FIG. 14 illustrates one embodiment of method for defining a network neighborhood for a mobile object as the result of a network topology change.

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION

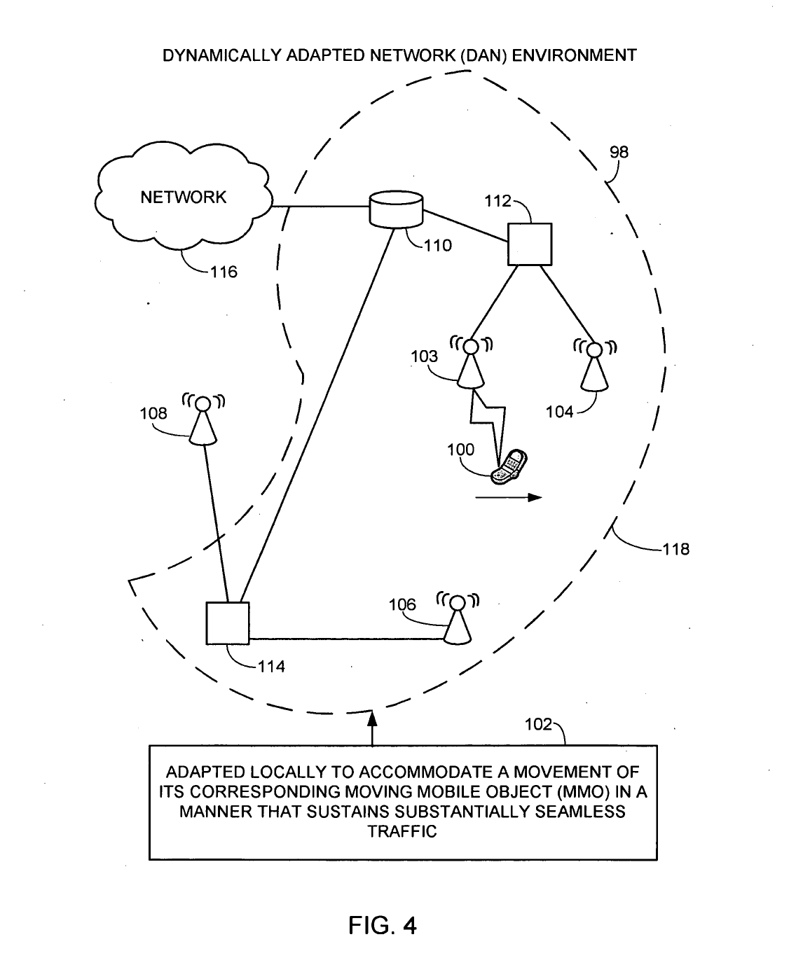

FIG. 4 schematically illustrates one embodiment of a dynamically adapted network (DAN) environment 98. The DAN environment 98 has one or more mobile objects (MO's) 100 which may or may not be moving. If the mobile object (MO) 100 is moving, it may be referred to as a moving mobile object (MMO) 100. The DAN environment 98 is adapted locally 102 to accommodate a movement of its corresponding mobile object (MO) 100 in a manner that sustains substantially seamless traffic. Embodiments of how this adaptation may be accomplished will be discussed in more detail, but it is important to note that since the DAN network 98 takes on the burden of sustaining seamless traffic for a moving mobile object (MMO) 100, the mobile objects (MO's) 100 only play a passive role and therefore do not need proprietary modifications or algorithms in order to participate and seamlessly roam in the network 98. In a broader sense, a mobile object (MO) may refer to any moving device connected to the network. Examples of suitable mobile objects may include, but are not limited to mobile phones, healthcare monitors, automatic traffic control devices, object location monitors, environmental detectors, municipal and state utilities, emergency service devices, general hazards service devices, military application devices, public transportation service devices, police devices, fire and rescue devices, educational devices, and airport terminal devices. Other examples of suitable mobile objects (MO's) may be mobile network infrastructures, such as, but not limited to mobile routers and mobile gateways. Such mobile networking infrastructures may be located onboard moving objects, such as trains.

The MO 100 is capable of wirelessly communicating with a network connection point (NCP) 103. Typically, a plurality of NCP's are provided in a DAN environment 98, such as, for example, additional NCP's 104, 106, and 108. A network connection point (NCP) refers to a point of the network which is capable of accommodating connections with a plurality of MO's. One example of an NCP is an access point (AP). An access point (AP) refers to a wireless network connection point.

The DAN environment 98 may also include one or more network objects, such as network objects 110, 112, 114 which couple the NCP's 103, 104, 106, 108 together and to other elements of a network 116. Examples of network objects 110, 112, 114 may include, but are not limited to switches, routers, subnet routers, and gateways.

One of the key ways that the DAN network 98 is adapted to accommodate movement of its corresponding mobile object (MO) 100 is that it defines or identifies a network neighborhood 118 for the MO 100. This network neighborhood 118, or neighboring group, may refer to a selected group of nodes which may include a current NCP 103 that the MO 100 is connected-to, other NCP's, and any network objects necessary to provide communication traffic between the current NCP and one or more other NCP's. The network neighborhood 118 follows the mobile object (MO) 100. Unlike prior art attempts to provide seamless roaming which view the MO as a lone object in a network, the solution embodiments provided herein, and their equivalents, treat the MO 100 as part of a network neighborhood 118 which may be continually adapted to provide substantially seamless traffic by avoiding the typical layer 2 and layer 3 roaming problems which were discussed in the background.

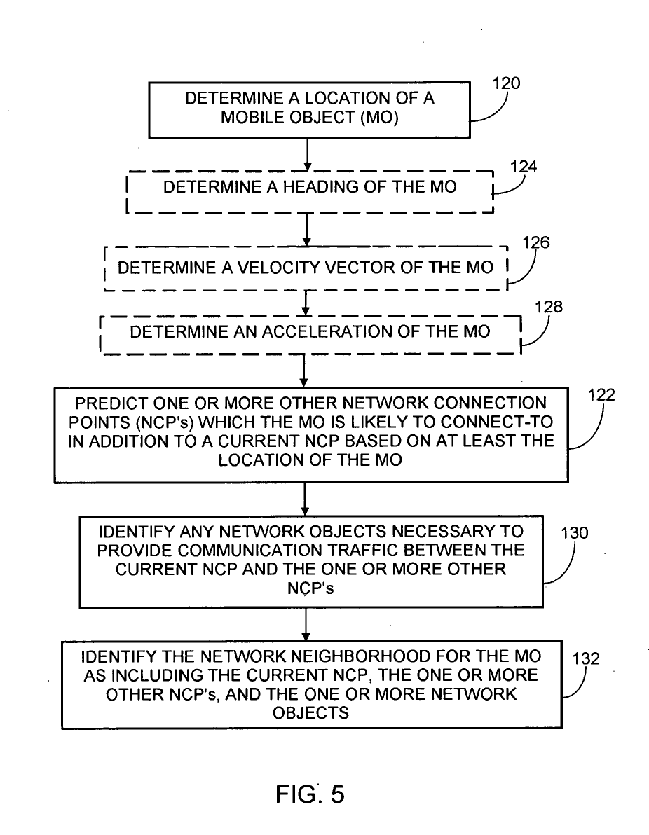

FIG. 5 illustrates one embodiment of a method of identifying a network neighborhood for a mobile object (MO). A location of the MO is determined 120. This location determination can be made in many different ways. For example, the NCP which the MO is connected-to may have a defined coverage area. Therefore, the location of the MO may be inferred from the location (coverage area) of the NCP which it is currently connected-to. This inferred location of the MO basically narrows-down the possible location of the MO to the coverage area of the current NCP. In other examples, the location of the MO may be determined 120 by triangulating the position of the MO. Those skilled in the art are familiar with a variety of ways to use signal triangulation to determine a transmitter's position. Such a triangulation location determination can be more precise than designating the position as within a particular coverage area. Still other embodiments may use positional information provided by the mobile object (MO), for example global positioning system (GPS) coordinates. It should be noted, however, that the methods and systems provided herein are intended to work with a wide variety of mobile objects and it is recognized that not all mobile objects will have GPS capabilities, so systems which are able to locate the MO's independently of the MO are preferred. Still, GPS will become more viable in the future as more and more MO's have this capability. Those skilled in the art will be familiar with other methods of locating a mobile object, and such equivalent methods are also intended to be covered by this disclosure.

Being connected to the network, the mobile object (MO) is already connected to a current network connection point (NCP). One or more other NCP's which the MO is likely to connect-to (in addition to the current NCP) are predicted 122 based on at least the location of the MO. In the case where the location of the MO has been inferred from the current NCP it is connected-to (in otherwords, the MO is located somewhere within the known coverage area of the current NCP), the predicted one or more other NCP's may include NCP's which have coverage areas adjacent to the current NCP. In the case where the location of the MO has been determined more precisely, for example by triangulation or receipt of GPS coordinates, the other NCP's may be chosen which have coverage areas in proximity to the more precise location.

It should be noted that the predicted 122 other NCP's are based on at least the location of the MO. Other embodiments may also optionally determine 124 a heading of the MO. A heading may be determined by comparing separate location results for the MO at different times. With location and heading available for the MO, the step of predicting 122 one or more other NCP's which the MO is likely to connect-to may include selecting one or more other NCP's which substantially lie in the direction of the MO's heading given the MO's location.

Still other embodiments may optionally determine 126 a velocity vector of the mobile object (MO). A velocity vector may be determined similarly to a heading, which gives the direction component, but also by dividing the distance between the two measurements which were used to determine the heading by the time between measurements to obtain the velocity of the MO. With location and a velocity vector available for the MO, the step of predicting 122 one or more other NCP's which the MO is likely to connect-to may include selecting one or more other NCP's which substantially lie in the direction of the MO's velocity vector and within a distance the MO is likely to cover based on its velocity.

Still other embodiments may optionally determine 128 an acceleration in addition to the velocity of the mobile object (MO). An acceleration may be determined by taking the time derivative of several velocity measurements. With velocity and acceleration available for the MO, the step of predicting 122 one or more other NCP's which the MO is likely to connect-to may include selecting one or more other NCP's which substantially lie in the direction of the MO's velocity vector and within a distance the MO is likely to cover based on its velocity and acceleration.

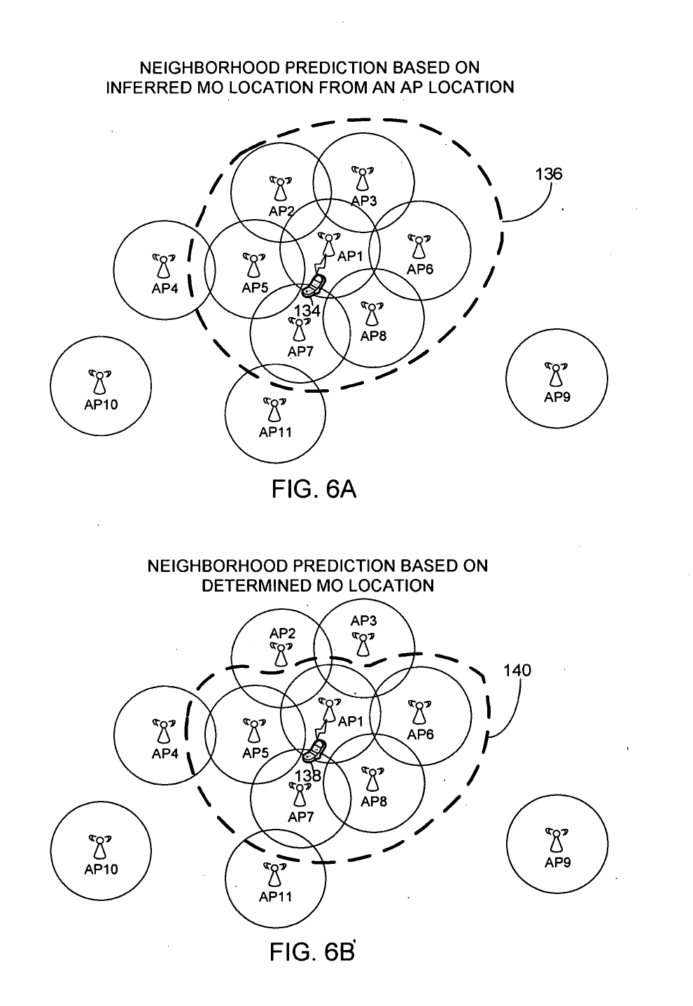

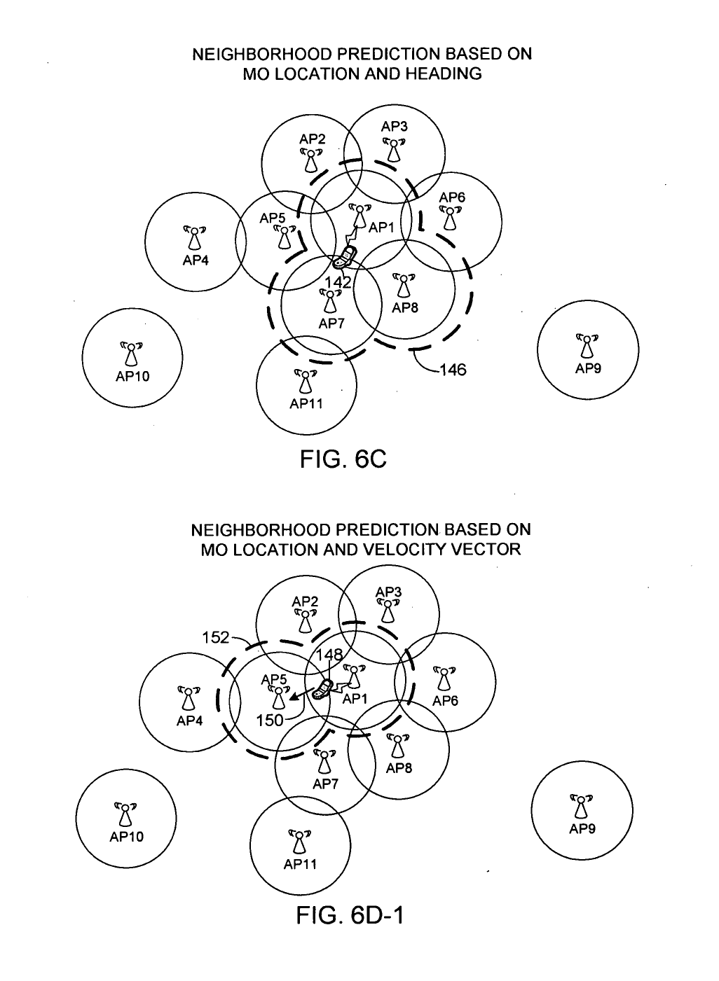

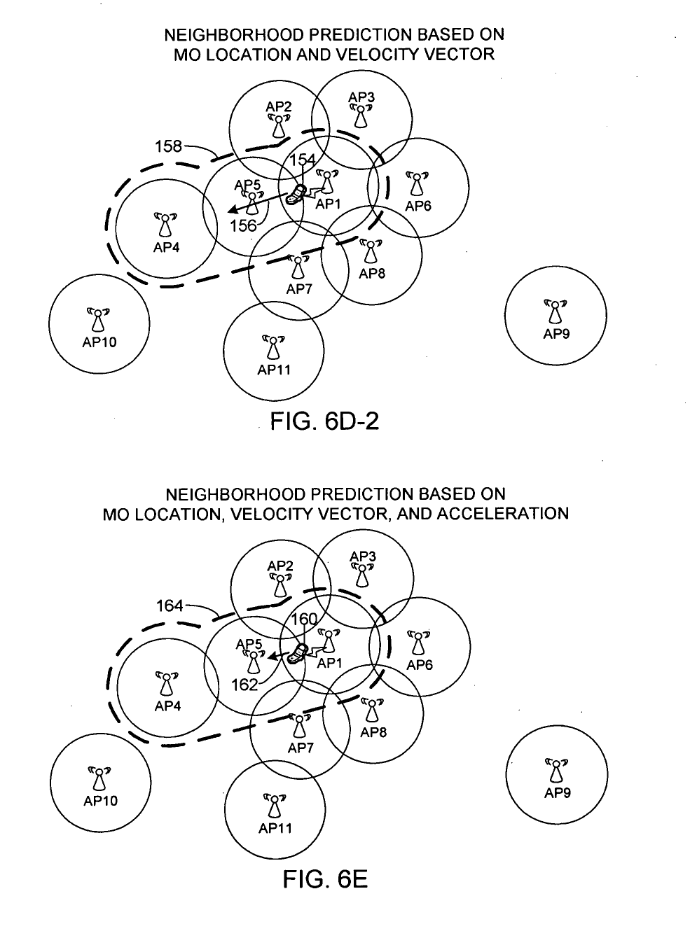

FIGS. 6A-6E, which will be covered later in this specification, illustrate graphic examples of embodiments where other NCP's are predicted as has been described above.

Referring back to FIG. 5, the current NCP which the mobile object (MO) is connected-to is known, and one or more other NCP's which the MO is likely to connect-to have been predicted. Any network objects necessary to provide communication traffic between the current NCP and the one or more other NCP's are identified 130. As just one example, the current NCP and the one or more other NCP's may be coupled via a router, so the router would be a network object necessary to provide communication traffic. In another example, the current NCP and the one or more other NCP's may be on different subnets, coupled via separate routers and a subnet router. In this case, the separate routers and the subnet router would be identified as necessary network objects.

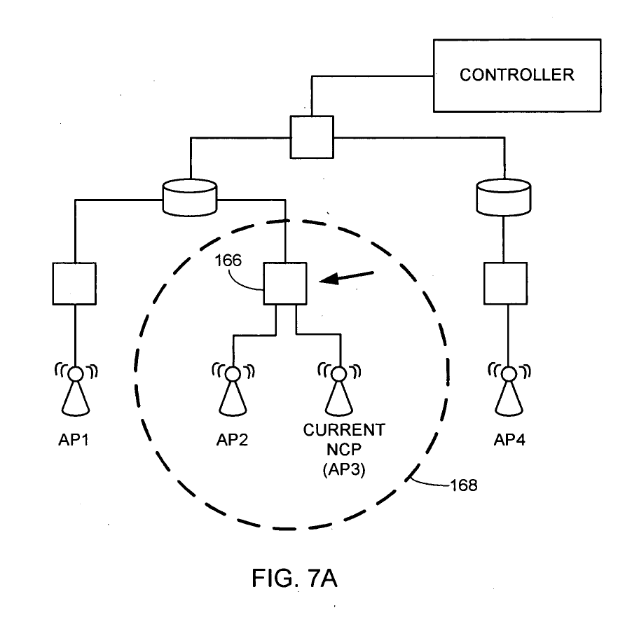

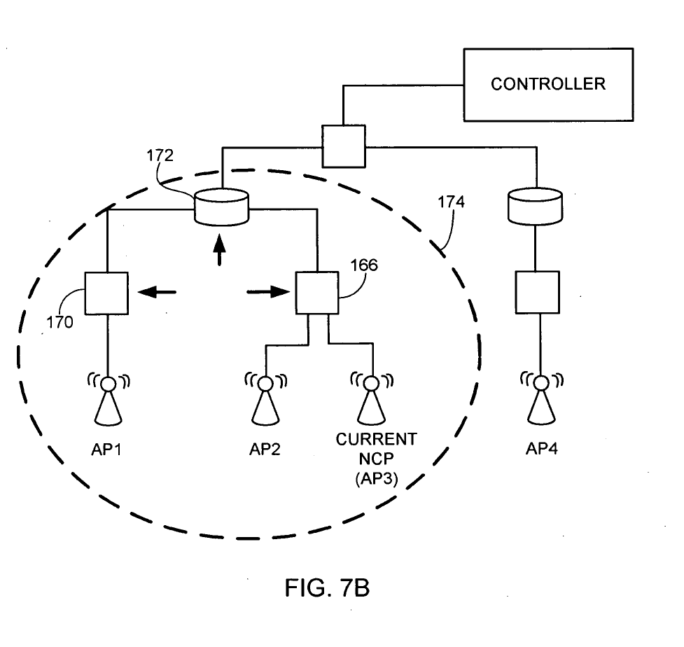

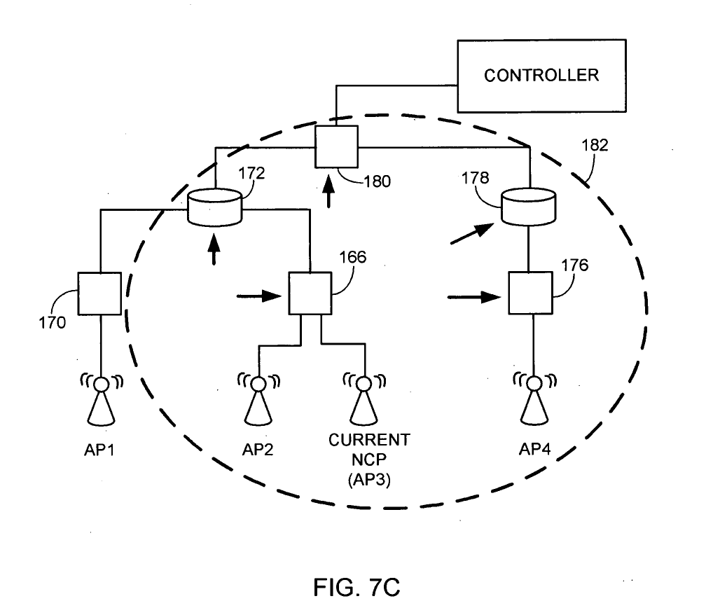

FIGS. 7A-7C, which will be covered later in this specification, illustrate graphic examples of embodiments where necessary network objects are identified as has been described above.

Referring back to FIG. 5, the network neighborhood for the MO is identified 132 as including the current NCP, the one or more other NCP's, and the one or more network objects. Although discussed in the context of a single MO for simplicity, the process embodied in FIG. 5 may be implemented separately for multiple MO's, each having their own network neighborhood following them around. The network neighborhoods may be continually updated as desired so that the network neighborhood information stays relatively current.

FIGS. 6A-6E schematically illustrate example embodiments of predicted network connection points which are assigned to part of a network neighborhood based on at least a location of a mobile object (MO). FIG. 6A schematically illustrates an embodiment of a network neighborhood prediction based on inferred MO location from an access point (AP) location. Various network connection points, in this case access points (AP1-AP11) are illustrated as part of the network in FIG. 6A. The coverage areas for each AP are known, and illustrated as the circles surrounding each AP. The current NCP is AP1, which is coupled to mobile object 134. Since the MO 134 is coupled to AP1, it is known to be somewhere within the coverage area of AP1. Therefore, in this example, it may be predicted that the other NCP's which the MO 134 is likely to connect-to are those with coverage areas that overlap or are adjacent to the coverage area of AP1, namely, AP2, AP3, AP5, AP6, AP7, and AP8. Although the eventual network neighborhood 136 is also likely to include network objects which provide communication between the current NCP and the predicted other NCP's, the beginnings of the network neighborhood 136 have been sketched within the dashed line of FIG. 6A to illustrate how the current NCP (AP1) and the predicted other NCP's (AP2, AP3, AP5, AP6, AP7, and AP8) are part of the network neighborhood 136.

FIG. 6B schematically illustrates an embodiment of a network neighborhood prediction based on determined MO location, for example by triangulation. Various network connection points, in this case access points (AP1-AP11) are illustrated as part of the network in FIG. 6B. The coverage areas for each AP are known, and illustrated as the circles surrounding each AP. The current NCP is AP1, which is coupled to mobile object 138. The determined location of MO 138 is illustrated. Therefore, in this example, it may be predicted that the other NCP's which the MO 138 is likely to connect-to are those with coverage areas that overlap or are adjacent to the determined location of MO 138, namely, AP5, AP6, AP7, and AP8. Although the eventual network neighborhood 140 is also likely to include network objects which provide communication between the current NCP and the predicted other NCP's, the beginnings of the network neighborhood 140 have been sketched within the dashed line of FIG. 6B to illustrate how the current NCP (AP1) and the predicted other NCP's (AP5, AP6, AP7, and AP8) are part of the network neighborhood 140.

FIG. 6C schematically illustrates an embodiment of a network neighborhood prediction based on determined MO location and heading. Various network connection points, in this case access points (AP1-AP11) are illustrated as part of the network in FIG. 6C. The coverage areas for each AP are known, and illustrated as the circles surrounding each AP. The current NCP is AP1, which is coupled to mobile object 142. The determined location of MO 142 is illustrated, as is the heading 144. Therefore, in this example, it may be predicted that the other NCP's which the MO 142 is likely to connect-to are those with coverage areas that overlap or are adjacent to the determined location of MO 142 in or near the direction the MO 142 is heading, namely, AP7 and AP8. Although the eventual network neighborhood 146 is also likely to include network objects which provide communication between the current NCP and the predicted other NCP's, the beginnings of the network neighborhood 146 have been sketched within the dashed line of FIG. 6C to illustrate how the current NCP (AP1) and the predicted other NCP's (AP7 and AP8) are part of the network neighborhood 146.

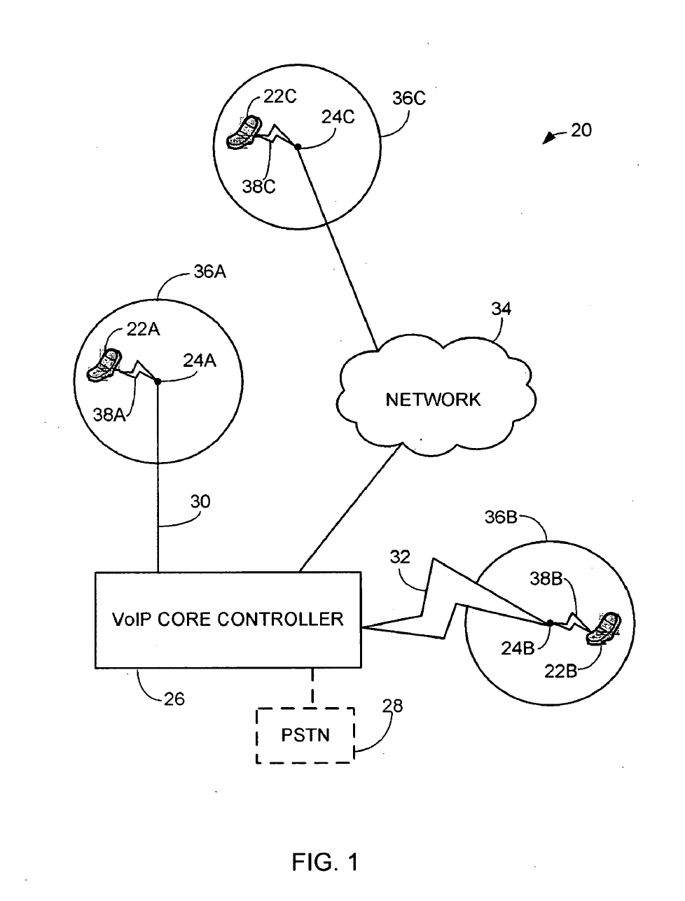

FIG. 6D-1 schematically illustrates a first embodiment of a network neighborhood prediction based on determined MO location and a velocity vector. Various network connection points, in this case access points (AP1-AP11) are illustrated as part of the network in FIG. 6D-1. The coverage areas for each AP are known, and illustrated as the circles surrounding each AP. The current NCP is AP1, which is coupled to mobile object 148. The determined location of MO 148 is illustrated, as is the velocity vector 150. In this example, the velocity is relatively small in the vector direction. Therefore, in this example, it may be predicted that the other NCP's which the MO 148 is likely to connect-to are those with coverage areas that overlap or are adjacent to the determined location of MO 148 in or near the direction the MO 148 is heading and within a distance the MO 148 is likely to cover based on its velocity vector. Since the velocity is small in this example, the predicted other NCP is AP5. Although the eventual network neighborhood 152 is also likely to include network objects which provide communication between the current NCP and the predicted other NCP, the beginnings of the network neighborhood 152 have been sketched within the dashed line of FIG. 6D-1 to illustrate how the current NCP (AP1) and the predicted other NCP (AP5) are part of the network neighborhood 152.

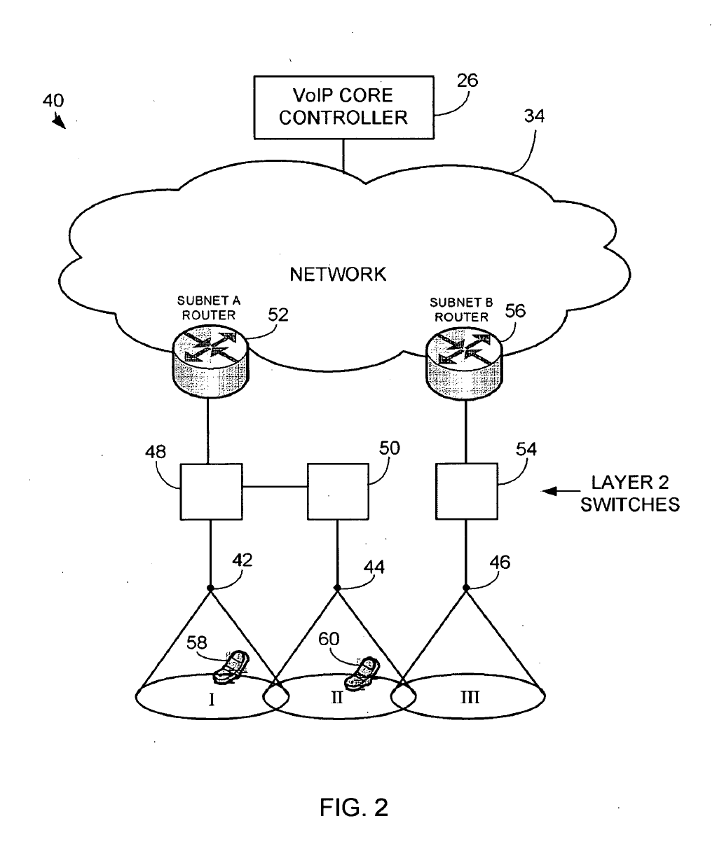

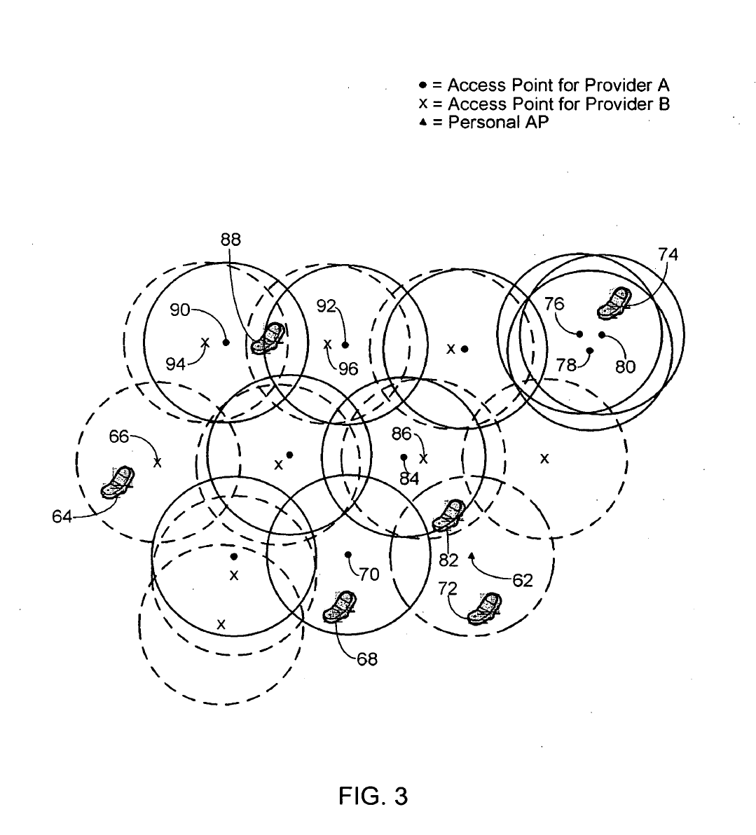

FIG. 6D-2 schematically illustrates a second embodiment of a network neighborhood prediction based on determined MO location and a velocity vector. Various network connection points, in this case access points (AP1-AP11) are illustrated as part of the network in FIG. 6D-2. The coverage areas for each AP are known, and illustrated as the circles surrounding each AP. The current NCP is AP1, which is coupled to mobile object 154. The determined location of MO 154 is illustrated, as is the velocity vector 156. In this example, the velocity is relatively large in the vector direction. Therefore, in this example, it may be predicted that the other NCP's which the MO 154 is likely to connect-to are those with coverage areas which overlap or are adjacent to the determined location of MO 154 in or near the direction the MO 154 is heading and within a distance the MO 154 is likely to cover based on its velocity vector. Since the velocity is large in this example, the predicted other NCP's are AP4 and AP5. Although the eventual network neighborhood 158 is also likely to include network objects which provide communication between the current NCP and the predicted other NCP, the beginnings of the network neighborhood 158 have been sketched within the dashed line of FIG. 6D-2 to illustrate how the current NCP (AP1) and the predicted other NCP's (AP4 and AP5) are part of the network neighborhood 158.

FIG. 6E schematically illustrates a first embodiment of a network neighborhood prediction based on determined MO location, velocity vector, and acceleration. Various network connection points, in this case access points (AP1-AP11) are illustrated as part of the network in FIG. 6E. The coverage areas for each AP are known, and illustrated as the circles surrounding each AP. The current NCP is AP1, which is coupled to mobile object 160. The determined location of MO 160 is illustrated, as is the velocity vector 162. In this example, the velocity is relatively small in the vector direction, however the acceleration is large. Therefore, in this example, it may be predicted that the other NCP's which the MO 160 is likely to connect-to are those with coverage areas which overlap or are adjacent to the determined location of MO 160 in or near the direction the MO 160 is heading and within a distance the MO 160 is likely to cover based on its velocity vector and acceleration. Even though the velocity is small in this example, the velocity is expected to increase based on the large acceleration, and therefore the predicted other NCP's are AP4 and AP5. Although the eventual network neighborhood 164 is also likely to include network objects which provide communication between the current NCP and the predicted other NCP, the beginnings of the network neighborhood 164 have been sketched within the dashed line of FIG. 6E to illustrate how the current NCP (AP1) and the predicted other NCP's (AP4 and AP5) are part of the network neighborhood 164.

The embodiments of FIGS. 6A-6E are illustrative only, and it should be understood that the concepts disclosed herein are applicable to a variety of network connection point configurations, mobile object positions, mobile object headings, mobile object velocities, and mobile object accelerations.

FIGS. 7A-7C schematically illustrate example embodiments of network objects which are included in a network neighborhood definition based on a current network connection point (NCP) and predicted NCP's which a mobile object (MO) might connect-to. The previous discussions and examples have illustrated how other possible NCP's are predicted in addition to the current NCP to be a part of the network neighborhood. Network objects are often necessary to provide communication between the current NCP and the predicted other NCP's, and as such, these network objects also need to be identified as part of the network neighborhood.

In the example of FIG. 7A, the current NCP is AP3. Using one of the above discussed techniques, or their equivalents, to predict other NCP's based on at least a location of the MO, AP2 was identified as belonging to the network neighborhood for the MO along with the current NCP (AP3). In this example a router 166 is identified as the network object which is necessary to provide communication traffic between the current NCP (AP3) and the predicted other NCP (AP2). As a result, the network neighborhood 168 is defined to include current NCP (AP3), predicted other NCP (AP2), and the network object 166.

In the example of FIG. 7B, the current NCP is AP3. Using one of the above discussed techniques, or their equivalents, to predict other NCP's based on at least a location of the MO, AP1 and AP2 were identified as belonging to the network neighborhood for the MO along with the current NCP (AP3). In this example routers 166 and 170 and subnet router 172 are identified as the network objects which are necessary to provide communication traffic between the current NCP (AP3) and the predicted other NCP's (AP1 and AP2). As a result, the network neighborhood 174 is defined to include current NCP (AP3), predicted other NCP's (AP1 and AP2), and the network objects 166, 170, and 172.

In the example of FIG. 7C, the current NCP is AP3. Using one of the above discussed techniques, or their equivalents, to predict other NCP's based on at least a location of the MO, AP2 and AP4 were identified as belonging to the network neighborhood for the MO along with the current NCP (AP3). In this example routers 166 and 176, subnet routers 172 and 178, and switch 180 are identified as the network objects which are necessary to provide communication traffic between the current NCP (AP3) and the predicted other NCP's (AP2 and AP4). As a result, the network neighborhood 182 is defined to include current NCP (AP3), predicted other NCP's (AP2 and AP4), and the network objects 166, 176, 172, 178, and 180.

The embodiments of FIGS. 7A-7C are illustrative only, and it should be understood that the concepts disclosed herein are applicable to a variety of network connection points and network objects.

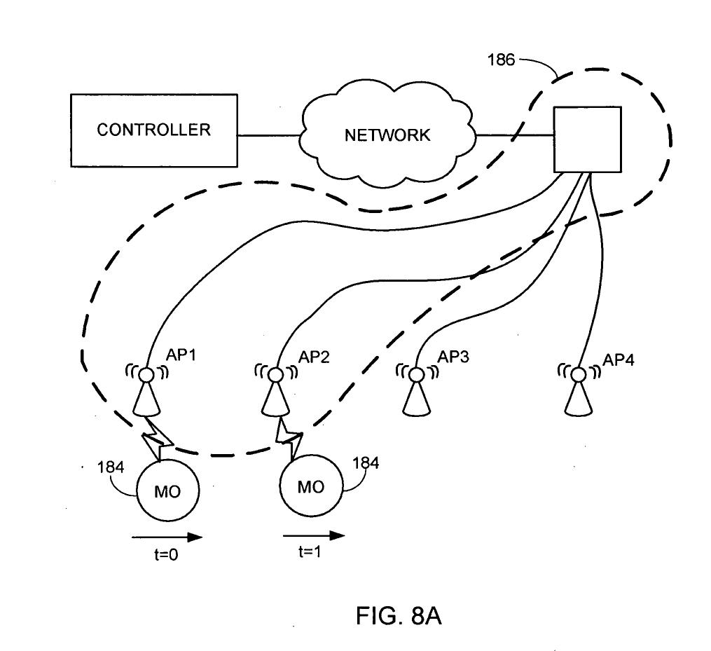

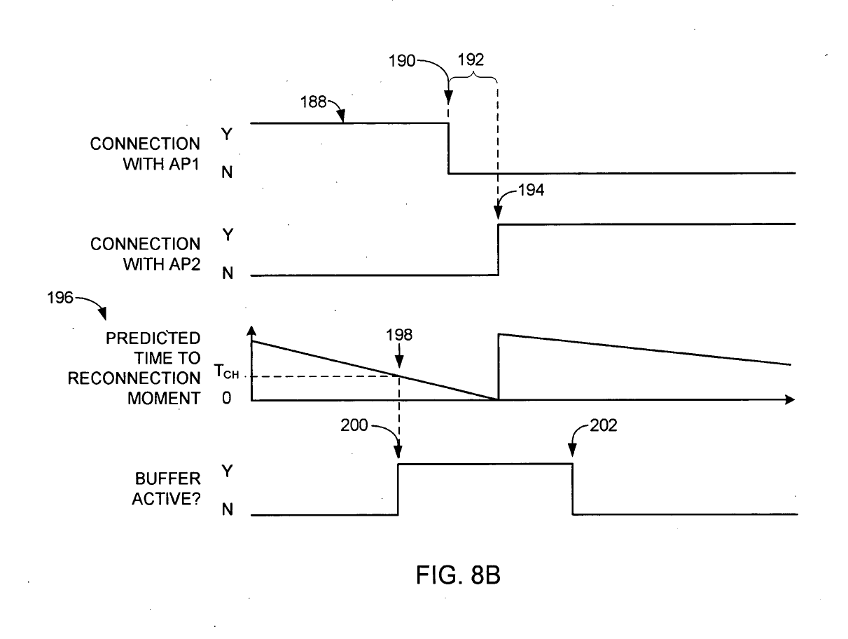

While identifying the network neighborhood is useful, in order to enable seamless wireless roaming of a mobile object on a wireless network, the network neighborhood must be used properly to avoid problems associated with delays in reconnection times when disconnecting from one NCP and connecting to another. Referring to FIG. 8A, a mobile object (MO) 184 is initially connected to AP1 at a time t=0, and is moving from left to right. Based on the current location of the MO 184 and its heading, the network neighborhood may be identified at time t=0 as neighborhood 186. As FIG. 8B illustrates, initially, there is a connection 188 with AP1. As the MO moves to the right, at some point, the connection with AP1 will be lost 190, and after a reconnection time 192, the connection with AP2 will begin 194. By predicting the ongoing/future NCP's (in this case AP2) as part of the network neighborhood identification process, and by tracking at least the location of the MO, the reconnection moment can be predicted prior to disconnecting from the current AP. The predicted time to the reconnection moment may be continually evaluated 196 and monitored. A changeover time (T_{CH}) may also be defined which includes the sum of all the time which will be necessary to reconnect the MO to the predicted future NCP. This changeover time (T_{CH}) can include time for reconnections, time for network identifiers (NI's) to change or be re-mapped, time for routing solutions, etc. When the predicted time to the reconnection moment gets down to the changeover time (T_{CH}) 198, data streams to and from the MO are buffered 200. Near the predicted reconnection moment 194, the MO is reconnected to the AP2, and not less than T_{CH} seconds after reconnection, the buffering is stopped 202. The buffered data streams are rerouted to the MO 184 at its new NCP. The mobile object maintains a constant network identifier (NI), network identifiers are managed within the network neighborhood that follows the MO, and layer 2 and layer 3 roaming problems are avoided.

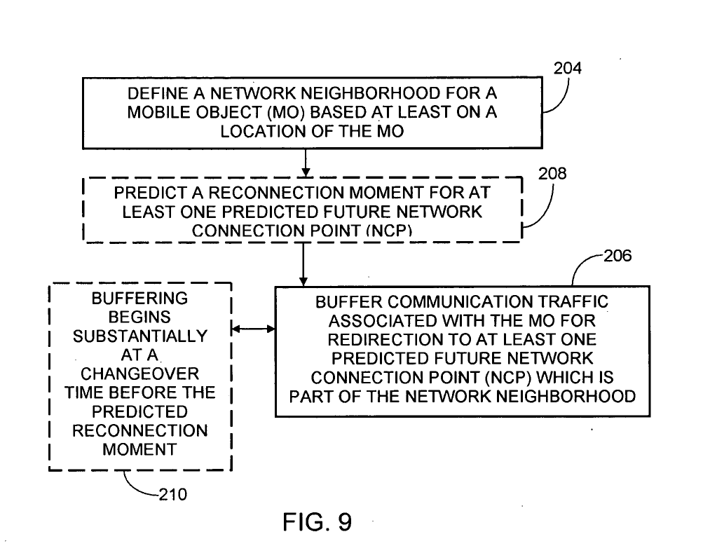

Accordingly, FIG. 9 illustrates one embodiment of a method of enabling seamless wireless roaming of a mobile object (MO) on a wireless network. A network neighborhood is defined 204 for a mobile object (MO) based at least on a location of the MO. Various embodiments of defining the network neighborhood have been discussed above. Communication traffic associated with the MO is buffered for redirection to at least one predicted future network connection point (NCP) which is part of the network neighborhood. The buffering can occur at an arbitrary time point, but preferably, to conserve system resources, a reconnection moment is predicted 208 for at least one predicted future network connection point (NCP). In this preferred case, the buffering 206 begins 210 substantially at a changeover time (T_{CH}) before the predicted reconnection moment.

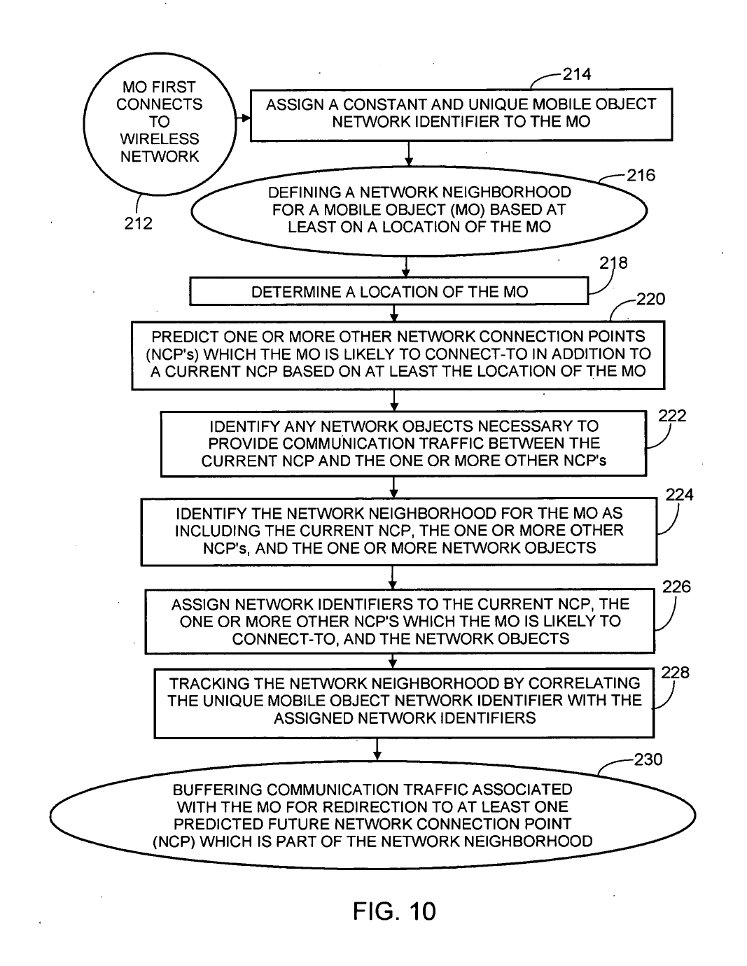

FIG. 10 illustrates another embodiment of a method of enabling seamless wireless roaming of a mobile object (MO) on a wireless network. When a mobile object (MO) first connects 212 to a wireless network, a constant and unique mobile object network identifier (NI_{MO}) is assigned 214 to the MO. This NI_{MO} may be based on a unique number inherent to the MO, such as a MAC address, or may be assigned by a system controller. A network neighborhood is defined 216 for the MO based at least on a location of the MO. The definition of this network neighborhood may take several actions. A location is determined 218 for the MO. One or more other network connection points (NCP's) which the MO is likely to connect-to are predicted 220 in addition to a current NCP based on at least the location of the MO. Any network objects necessary to provide communication traffic between the current NCP and the one or more other NCP's is identified 222. The network neighborhood for the MO is identified 224 as including the current NCP, the one or more other NCP's, and the one or more network objects. Neighborhood network identifiers are assigned 226 to the current NCP, the one or more other NCP's which the MO is likely to connect-to, and the network objects. The network neighborhood is tracked 228 by correlating the unique mobile object network identifier with the assigned neighborhood network identifiers. In this way, the network objects follow after the MO. The definition of the network neighborhood 216, and its related steps (218-228) are repeated to account for possible movement of the mobile object (MO). Eventually, communication traffic associated with the MO is buffered 230 for redirection to at least one predicted future network connection point (NCP) which is part of the network neighborhood.

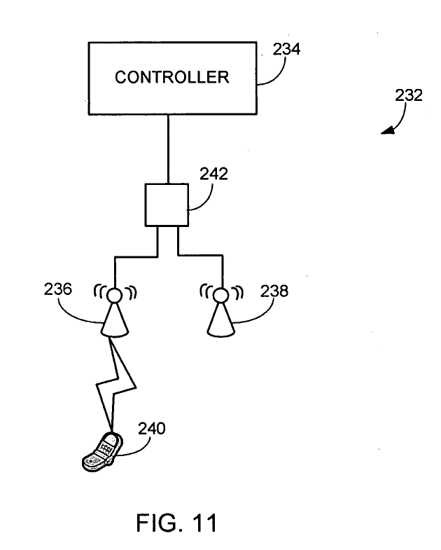

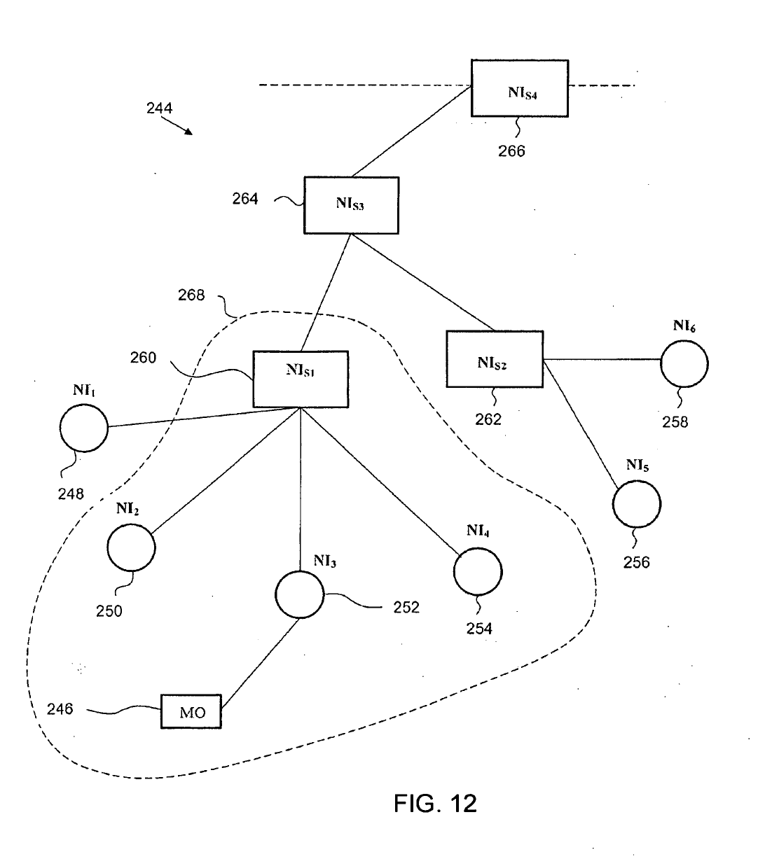

FIG. 11 schematically illustrates one embodiment of a system 232 for mobile networking. The system 232 has a controller 234 and a plurality of network connection points (NCP's) 236, 238 configured to communicate with a mobile object (MO) 240. The system 232 also has at least one network object 242 which couples the plurality of NCP's 236, 238 to the controller 234. Either the controller 234, the at least one network object 242, the plurality of NCP's 236, 238, or any combination thereof are configured to 1) define a network neighborhood for the MO 240 based at least on a location of the MO; and 2) buffer communication traffic associated with the MO 240 for redirection to at least one predicted future network connection point (NCP) which is part of the network neighborhood. Embodiments of various methods and their equivalents which may be employed to implement these configurations have been discussed above and will be discussed further in the following embodiments of FIGS. 12-14.

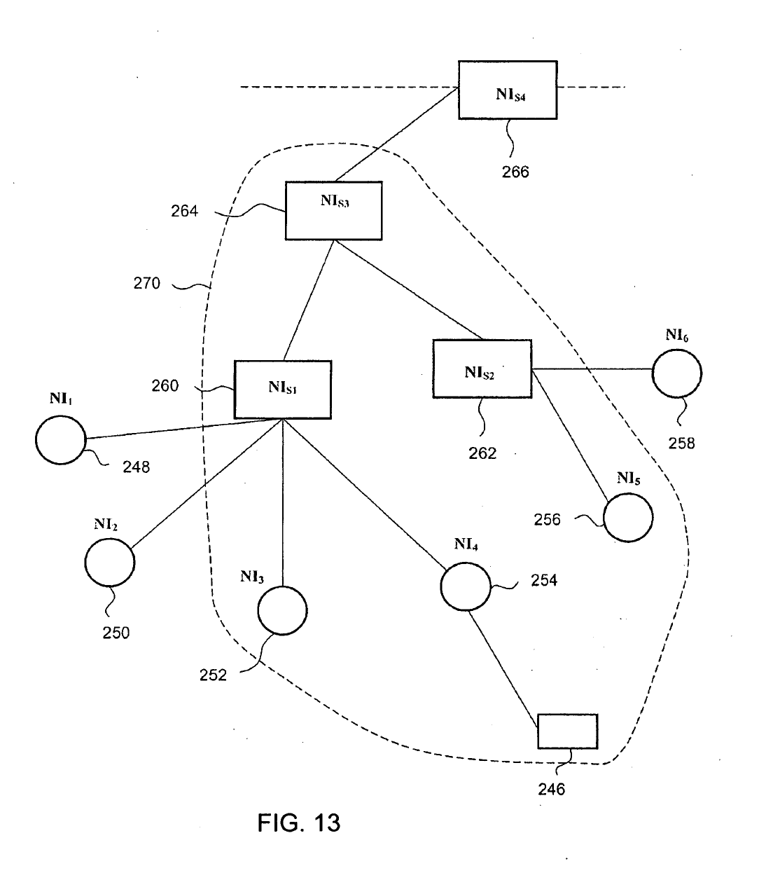

The claimed invention discloses a process and system for repeatedly and dynamically adapting a network to accommodate movement of MO's, while sustaining seamless communication traffic of the MO. For that matter, the embodied methods may be embedded into the network and are based on two principal functions. The first is a caching function accommodating a predefined communication traffic timeout delay. The second routine is used to define a neighborhood of several distinct network nodes which are adjacent to the network connection point of a mobile device. The second routine further assigns to each of the neighborhood network nodes, an additional neighborhood network identifier associated with the mobile device network identifier NI_{MO}. Assigning additional identifiers to the neighborhood nodes maps the MO identifier with the predefined network node identifiers to create neighborhood links leading from every neighborhood network node to the rest of the network outside the neighboring group. If the MO connects to an NCP after disconnecting from the previous NCP, within a predefined time limit set by caching the communication traffic, the system renews communication traffic through neighborhood links merged appropriately with re-caching the previous communication traffic so that communication traffic is sustained without interruption. When the mobile device connects to a new NCP, the process defines a new neighborhood associated with the new NCP of the mobile device. Nodes included in the previous neighborhood keep the assigned neighborhood network identifiers (NI's) of the previous neighboring nodes. New neighboring nodes may be assigned additional neighboring NI values taken from a list of predefined neighboring NI values, while previously assigned neighboring NI values of nodes excluded from the new neighboring group are released and returned to the pool of NI's for further use. An example of the assignment of neighboring NI's will be discussed with regard to FIGS. 12 and 13.

This process repeats in a Dynamically Adapted Network (DAN) environment. Implementation of the process is commonly provided by the network and it is not required to apply any change to the MO. Each MO connected to the network becomes a center of a small neighboring sub network (network neighborhood) which is adapted locally to accommodate the movement of the MO in a manner that sustains seamless communication traffic. By contrast, presently available networks are using various techniques for controlling the network centrally.

Reference is now made to FIG. 12 which schematically illustrates an embodiment of an infrastructure 244 of a network topology and a single mobile object (MO) 246. The MO 246 is assigned a constant network identifier of NI_{MO}. In this example, the network topology includes six distinct NCP network nodes 248, 250, 252, 254, 256, and 258 which the MO 246 may connect-to. Suitable examples of NCP's include, but are not limited to access points of a wireless network, infrared communication nodes, or fixed cable connections. The network topology also includes four network router nodes 260, 262, 264, and 266. Suitable examples of router nodes include routers, switches, servers, wireless hubs, infrared routers, or any combination thereof Independent of any network neighborhood, the network knows the following network elements as follows:

| Description | Network ID |
|---|---|
| Mobile Object 246 | NI_{MO} |
| NCP 248 | NI₁ |
| NCP 250 | NI₂ |
| NCP 252 | NI₃ |
| NCP 254 | NI₄ |
| NCP 256 | NI₅ |
| NCP 258 | NI₆ |
| Router Node 260 | NI_{S1} |
| Router Node 262 | NI_{S2} |
| Router Node 264 | NI_{S3} |
| Router Node 266 | NI_{S4} |

The mobile object (MO) 246 is connected to NCP 252. The network is adapted for sustaining uninterrupted communication with the MO 246. When the network operates without the embedded routines for accommodating mobile devices, abruptly disconnecting the MO 246 from the network and reconnecting the MO to another network node interrupts communication traffic. This is the result of the network creating a new communication link to the MO which is not related to the preceding link. When the network operates with the embedded algorithm according to the claimed invention, the network is adapted to accommodate seamless communication of the MO 246.

As an example, when the MO 246 connects to NCP 252, the network identifies a new device at node 252, and a connection is established between node 252 and the user device. A network neighborhood 268 is identified, for example using the techniques previously discussed. Different techniques may be used to vary the size of the selected neighborhood. The size of neighborhood selection may be traded-off between lower probabilities of communication interruption when a larger neighborhood is selected, versus a decrease in system resource requirements when the neighborhood size is reduced. Each of the network nodes in the network neighborhood is assigned a neighborhood network identifier, associated with the MO connected to the network. In this example, the network neighborhood includes NCP's 250, 252, and 254, as well as router node 260. The network neighborhood now knows the neighborhood elements as follows:

| | Network ID | |
|---|---|---|
| | (independent | Neighborhood |
| | of network | network |
| Description | neighborhood) | identifier |
| Mobile Object 246 | NI_{MO} | NI_{MO} |
| NCP 250 | NI₂ | NI_{MO3} |
| NCP 252 | NI₃ | NI_{MO1} |
| NCP 254 | NI₄ | NI_{MO2} |
| Router Node 260 | NI_{S1} | NI_{MOS1} |

The delay of communication traffic through the cache is made long enough to accommodate the time lag from the instance that an MO is disconnected from one NCP to the instance that the MO connects to a next NCP. Communication traffic is flowing out of the network neighborhood from the MO 246 to NCP 252 to router node 260 and out to router node 264.

Reference is now made to FIG. 13 which schematically illustrates a follow-on in time to the embodiment of the network of FIG. 12, whereas the MO 246 has been disconnected from NCP 252 and reconnected to NCP 254. A new network neighborhood 270 is defined by the system. The network neighborhood 270 in this embodiment includes NCP's 252, 254 and router node 260 from the preceding network neighborhood. The newly defined neighborhood no longer includes NCP 250 hence the neighborhood network identifier previously associated with NCP 250 (NI_{MO3}) is released and added to a database of new neighborhood network identifier values for future use. Newly added nodes include NCP 256 and router nodes 262, 264. The network neighborhood now knows the neighborhood elements as follows:

| | Network ID | |
|---|---|---|
| | (independent | |
| | of network | Neighborhood network |
| Description | neighborhood) | identifier |
| Mobile Object 246 | NI_{MO} | NI_{MO} (Constant) |
| NCP 252 | NI₃ | NI_{MO1} (Previous Carryover) |
| NCP 254 | NI₄ | NI_{MO2} (Previous Carryover) |
| NCP 256 | NI₅ | NI_{MO4} (New) |
| Router Node 260 | NI_{S1} | NI_{MOS1} (Previous Carryover) |
| Router Node 262 | NI_{S2} | NI_{MOS2} (New) |
| Router Node 264 | NI_{S3} | NI_{MOS3} (New) |

Cache for the communication traffic may now be located within router node 264. Communication traffic flows from the MO 246 to NCP 254, continues to router node 260 and into a cache located within router node 264. Communication traffic flows out of the cache into router node 266. The network identifies the communication traffic of the reconnected MO with the preceding communication traffic and links seamlessly the tail end of the communication traffic from the preceding MO network connection to the front end communication traffic of the new MO network connection. The network links the preceding and new sections of communication traffic by identifying the MO at the new location through the neighborhood network identifier values assigned to the network nodes. The process is carried out by the system continuously as well as applied to all the devices communicating through the network. The network assigns new neighborhood network identifiers to new neighboring nodes in the network and releases the neighborhood network identifiers when corresponding nodes are excluded from the network neighborhood. Consequently a dynamic resource allocation process is maintained by the network which helps to conserve system resources.

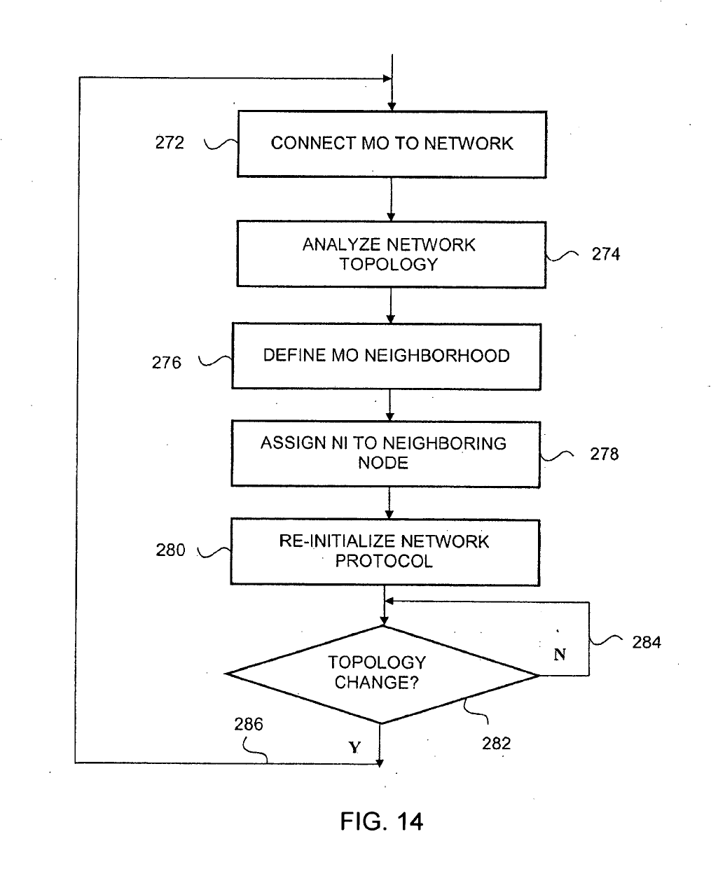

FIG. 14 illustrates an embodiment of a method for defining a network neighborhood for a mobile object (MO) as the result of a network topology change. The process begins with connecting 272 an MO to an end node. When the MO is connected to one of the network nodes, the network begins analyzing 274 the network topology for the purpose of defining 276 a network neighborhood for the MO. The network assigns 278 an additional NI (neighborhood network identifier) to each of the elements of the MO network neighborhood. The neighborhood network identifier values are used by the system to associate each of the neighborhood nodes with the corresponding MO. The values of the neighborhood network identifiers may be predetermined by the network according to MO requirements and topology of the network neighboring nodes. The network protocol is reinitialized 280. In the event that the MO was in the middle of communication traffic when disconnected from one node and connected to a new one, caching is for storing communication data during a timeout period while the MO is disconnected from the first node and not yet connected to a new node. Hence, caching accommodates sustaining seamless communication traffic of the MO during the time that the network adapts to a change in topology. Communication traffic in and out of the cache is preferably transmitted to the output node of the network neighborhood in order to minimize communication traffic. Following adapting the network to a new topology, the network monitors 282 topology status. As long as the network does not detect a topology change (change in at least the location of the MO), nothing new occurs 284. When a change in topology is detected (caused by MO movement), the process can begin again 286. Alternatively, if the network detects an unbalanced load condition, the network can instigate transferring an MO connection from one node to another one

The advantages of a wireless networking method and system have been discussed herein. Embodiments discussed have been described by way of example in this specification. It will be apparent to those skilled in the art that the forgoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of processing elements or sequences, or the use of numbers, letters, or other designations therefore, is not intended to limit the claims to any order, except as may be specified in the claims. Accordingly, the invention is limited only by the following claims and equivalents thereto.

What is claimed is:

1. A dynamically adapted network environment, comprising:
one or more mobile objects (MO's); and
one or more corresponding network neighborhoods wherein each of the one or more MO's is the center of a corresponding network neighborhood which is adapted locally to accommodate a movement of its corresponding MO in a manner that sustains substantially seamless communication traffic.

2. A method of identifying a network neighborhood for a mobile object (MO), comprising:
determining a location of the MO;
predicting one or more other network connection points (NCP's) which the MO is likely to connect-to in addition to a current NCP based on at least the location of the MO;
identifying any network objects necessary to provide communication traffic between the current NCP and the one or more other NCP's; and
identifying the network neighborhood for the MO as including the current NCP, the one or more other NCP's, and the one or more network objects.

3. The method of claim 2, wherein determining a location of the MO comprises inferring MO location from the location of the current NCP.

4. The method of claim 3, wherein predicting one or more other NCP's which the MMO is likely to connect-to comprises selecting one or more other NCP's which are adjacent to a coverage area of the current NCP.

5. The method of claim 2, wherein determining a location of the MO comprises triangulating the location of the MO.

6. The method of claim 5, wherein predicting one or more other NCP's which the MO is likely to connect-to comprises selecting one or more other NCP's which have coverage areas in proximity to the determined location of the MO.

7. The method of claim 2, further comprising determining a heading of the MO, and wherein predicting one or more other NCP's which the MO is likely to connect-to comprises selecting one or more other NCP's which substantially lie in the direction of the MO's heading.

8. The method of claim 2, further comprising determining a velocity vector of the MO, and wherein predicting one or more other NCP's which the MO is likely to connect-to comprises selecting one or more other NCP's which substantially lie in the direction of the MO's velocity vector and within a distance the MO is likely to cover based on its velocity vector.

9. The method of claim 8, further comprising determining an acceleration of the MO, and wherein predicting one or more other NCP's which the MO is likely to connect to further comprises selecting one or more other NCP's which substantially lie in the direction of the MO's velocity vector and within a distance the MO is likely to cover based on its velocity vector and acceleration.

10. A method of enabling seamless wireless roaming of a mobile object (MO) on a wireless network, comprising:
defining a network neighborhood for the MO based at least on a location of the MO; and
buffering communication traffic associated with the MO for redirection to at least one predicted future network connection point (NCP) which is part of the network neighborhood.

11. The method of claim 10, further comprising:
predicting a reconnection moment for the at least one predicted future NCP; and
wherein the buffering communication traffic associated with the MO for redirection to the at least one predicted future NCP begins substantially at a changeover time before the predicted reconnection moment.

12. The method of claim 10, wherein the changeover time is less than a time between reconnections of the MO between sequential NCP's.

13. The method of claim 10, wherein the buffering ends at a time not less than the changeover time after the reconnection moment.

14. The method of claim 10, wherein defining the network neighborhood for the MO based at least on a location of the MO further comprises:
determining the location of the MO;
predicting one or more other NCP's which the MO is likely to connect-to in addition to a current NCP based on at least the location of the MO;
identifying any network objects necessary to provide communication traffic between the current NCP and the one or more other NCP's;
identifying the network neighborhood for the MO as including the current NCP, the one or more other NCP's, and the one or more network objects; and
wherein the at least one predicted future NCP is selected from the one or more other NCP's.

15. The method of claim 14, wherein determining a location of the MO comprises inferring MO location from the location of the current NCP.

16. The method of claim 15, wherein predicting one or more other NCP's which the MO is likely to connect-to comprises selecting one or more other NCP's which are adjacent to a coverage area of the current NCP.

17. The method of claim 14, wherein determining a location of the MO comprises triangulating the location of the MO.

18. The method of claim 17, wherein predicting one or more other NCP's which the MO is likely to connect-to comprises selecting one or more other NCP's which have coverage areas in proximity to the determined location of the MO.

19. The method of claim 14, further comprising determining a heading of the MO, and wherein predicting one or more other NCP's which the MO is likely to connect-to comprises selecting one or more other NCP's which substantially lie in the direction of the MO's heading.

20. The method of claim 14, further comprising determining a velocity vector of the MO, and wherein predicting one or more other NCP's which the MO is likely to connect-to comprises selecting one or more other NCP's which substantially lie in the direction of the MO's velocity vector and within a distance the MO is likely to cover based on its velocity vector.

21. The method of claim 20, further comprising determining an acceleration of the MO, and wherein predicting one or more other NCP's which the MO is likely to connect to further comprises selecting one or more other NCP's which substantially lie in the direction of the MO's velocity vector and within a distance the MO is likely to cover based on its velocity vector and acceleration.

22. The method of claim 14, further comprising:
assigning a constant and unique mobile object network identifier to the MO following a first connection of the MO to the wireless network; and
wherein defining the network neighborhood for the MO based at least on the location of the MO further comprises:
a) assigning neighborhood network identifiers to the current NCP, the one or more other NCP's which the MO is likely to connect-to, and the network objects necessary to provide communication traffic between the current NCP and the one or more other NCP's; and
b) tracking the network neighborhood by correlating the unique mobile object network identifier with the assigned neighborhood network identifiers.

23. The method of claim 22, further comprising:
updating the network neighborhood by repeating the defining of the network neighborhood, and wherein:
assigned neighborhood network identifiers are maintained for elements from the previous definition of the network neighborhood which are still in the updated network neighborhood;
new elements of the updated network neighborhood which were not present in the previous network neighborhood are assigned new neighborhood network identifiers from a pool of available network identifiers; and
neighborhood network identifiers from elements of the previous definition of the network neighborhood which are no longer in the updated network neighborhood are returned to the pool of available network identifiers.

24. A system for mobile networking, comprising:
a) a controller;
b) a plurality of network connection points (NCP's) configured to communicate with a mobile object (MO);
c) at least one network object which couples the plurality of NCP's to the controller; and
d) wherein one or more of the controller, the plurality of NCP's, and the at least one network object are configured to:
1) define a network neighborhood for the MO based at least on a location of the MO; and
2) buffer communication traffic associated with the MO for redirection to at least one predicted future network connection point (NCP) which is part of the network neighborhood.

25. The system of claim 24, wherein one or more of the controller, the plurality of NCP's, and the at least one network object are further configured to:
predict a reconnection moment for the at least one predicted future NCP;
wherein:
i) the buffered communication traffic associated with the MO for redirection to the at least one predicted future NCP begins substantially at a changeover time before the predicted reconnection moment;
ii) the changeover time is less than a time between reconnections of the MO between sequential NCP's; and
iii) the buffering ends at a time not less than the changeover time after the reconnection moment.
